(19) United States
(12) Patent Application Publication
(10) Pub. No.: US 2026/0160959 A1
(43) Pub. Date: Jun. 11, 2026

(54) HETEROGENEOUS INTEGRATION STRUCTURE AND HETEROGENEOUS INTEGRATION WAFER

(71) Applicant: Industrial Technology Research Institute, Hsinchu (TW)

(72) Inventor: Sin-Jhu Wun, Hsinchu County (TW)

(73) Assignee: Industrial Technology Research Institute, Hsinchu (TW)

(21) Appl. No.: 18/984,956

(22) Filed: Dec. 17, 2024

(30) Foreign Application Priority Data
Dec. 11, 2024 (TW) 113148209

(51) Int. Cl. G02B 6/42

(52) U.S. Cl. CPC G02B 6/4214

(57) ABSTRACT

A heterogeneous integration structure includes a photonic integrated circuit and a light guiding device. The photonic integrated circuit includes a substrate, a light source, and an optical coupling element. The light source provides a first light to the optical coupling element. The light guiding device forms heterogeneous integration with the photonic integrated circuit, and includes a first lens and a first reflector. The first lens is disposed on the substrate and aligned with the optical coupling element. The first light coming from the optical coupling element sequentially passes through the first lens, gets reflected by the first reflector, and reaches a fiber connector. A second light coming from the fiber connector sequentially gets reflected by the first reflector, passes through the first lens, and reaches the optical coupling element. Provided is also a heterogeneous integration wafer.

### CROSS-REFERENCE TO RELATED APPLICATION

This application claims the priority benefit of Taiwan application serial no. 113148209, filed on Dec. 11, 2024. The entirety of the above-mentioned patent application is hereby incorporated by reference herein and made a part of this specification.

### TECHNICAL FIELD

The disclosure relates to a heterogeneous integration structure and a heterogeneous integration wafer.

### BACKGROUND

In typical semiconductor processes, wafer acceptance testing (WAT) is a very important in-line inspection, and may be used to determine the quality of the process as well as the quality of the dies. On the other hand, the measurement methods for light input and light output of photonic integrated circuits are more complex than circuit testing. How to perform WAT for photonic integrated circuits using a simple framework has become an urgent area for improvement.

### SUMMARY

A heterogeneous integration structure and a heterogeneous integration wafer are introduced herein, which use a simple framework to achieve optical coupling and greatly improve the packaging and testing efficiency of photonic integrated circuits.

According to an embodiment of the disclosure, a heterogeneous integration structure is provided, including a photonic integrated circuit and a light guiding device. The photonic integrated circuit includes a substrate, at least one light source, and at least one optical coupling element, in which the light source and the optical coupling element are disposed on the substrate, the light source is configured to generate a first light, and the optical coupling element is arranged in a path of the first light. The light guiding device forms heterogeneous integration with the photonic integrated circuit, and includes at least one first lens and a first reflector. The first lens is disposed on the substrate and aligned with the optical coupling element. The first reflector is disposed on the substrate. The first light coming from the optical coupling element sequentially passes through the first lens, gets reflected by the first reflector, and reaches a fiber connector, or the second light coming from the fiber connector sequentially gets reflected by the first reflector, passes through the first lens, and reaches the optical coupling element.

According to an embodiment of the disclosure, a heterogeneous integration wafer is provided, which includes a plurality of photonic integrated circuits arranged in an array and a plurality of light guiding devices forming heterogeneous integration with the photonic integrated circuits respectively. Each photonic integrated circuit includes a substrate, at least one light source, and at least one optical coupling element, in which the light source and the optical coupling element are disposed on the substrate, the light source is configured to generate a first light, and the optical coupling element is arranged in a path of the first light. Each light guiding device includes at least one first lens and a first reflector. The first lens is disposed on the substrate and aligned with the corresponding optical coupling element. The first reflector is configured on the substrate. The first light coming from the optical coupling element sequentially passes through the first lens, gets reflected by the first reflector, and reaches a fiber connector, or the second light coming from the fiber connector sequentially gets reflected by the first reflector, passes through the first lens, and reaches the optical coupling element.

Based on the above, the heterogeneous integration wafer provided by the embodiments of the disclosure includes multiple heterogeneous integration structures. The performance of each photonic integrated circuit may be tested through the detachable light guiding device of each heterogeneous integration structure. In particular, each light guiding device may be disposed on the substrate of each photonic integrated circuit without the need to cut the substrate. Therefore, the process of cutting the substrate can be omitted, and the structural strength of each heterogeneous integration structure and the heterogeneous integration wafer is high.

Several exemplary embodiments accompanied with figures are described in detail below to further describe the disclosure in details.

### BRIEF DESCRIPTION OF THE DRAWINGS

FIG. 1A shows a schematic view of a heterogeneous integration structure according to an embodiment of the disclosure.

FIG. 1B shows a schematic cross-sectional view of a partial structure of FIG. 1A on an X-Z plane.

FIG. 2 shows a schematic view of a heterogeneous integration wafer according to an embodiment of the disclosure.

### DETAILED DESCRIPTION OF DISCLOSED EMBODIMENTS

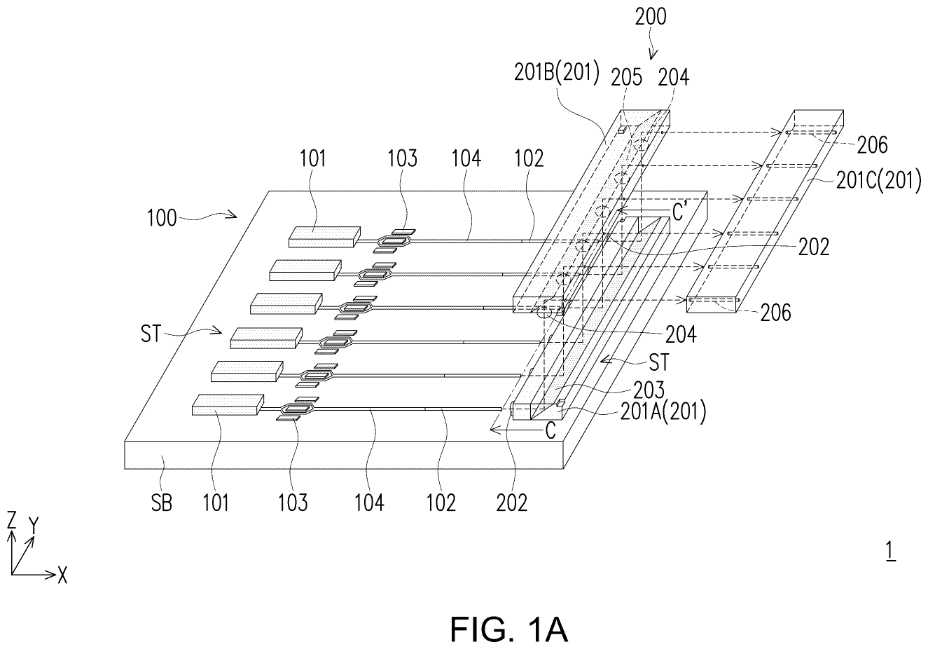

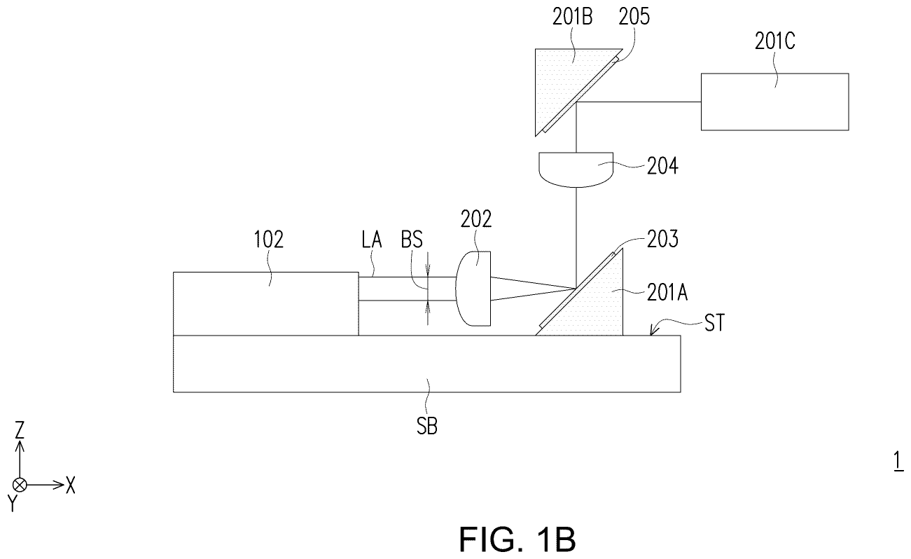

Referring to FIG. 1A and FIG. 1B, FIG. 1A shows a schematic view of a heterogeneous integration structure according to an embodiment of the disclosure, and FIG. 1B shows a schematic cross-sectional view of a partial structure of FIG. 1A on an X-Z plane.

A heterogeneous integration structure 1 may be implemented as a heterogeneous integration chip 1, and includes a photonic integrated circuit 100 and a light guiding device 200.

The photonic integrated circuit 100 includes a substrate SB, a plurality of light sources 101, and a plurality of optical coupling elements 102. The light sources 101 and the optical coupling elements 102 are disposed on a top surface ST of the substrate SB. The substrate SB may include silicon, III-V semiconductors, silicon nitride, lithium niobate, polymers, and the like. Each light source 101 may include a laser diode for emitting laser light LA, but the disclosure is not limited thereto. Each light source 101 may further include a light emitting diode (LED) or a micro light emitting diode (micro LED). Each optical coupling element 102 is arranged in the path of the laser light LA and may be, for example, a spot size converter. The spot size converter may include microlens to adjust the spot size of the laser light LA and the spot shape of the laser light LA, but the disclosure is not limited thereto.

In some embodiments, the photonic integrated circuit 100 may further include multiple optical modulators 103 and multiple waveguides 104, but the disclosure is not limited thereto. In the embodiments, the laser light LA coming from each light source 101 may sequentially reach a corresponding one of the optical modulators 103, the waveguides 104, and the optical coupling elements 102.

The light guiding device 200 form heterogeneous integration with the photonic integrated circuit 100, and includes a detachable module 201. The detachable module 201 includes a first component 201A, a second component 201B, and a third component 201C, in which the third component 201C may be implemented as a fiber connector, with multiple discrete optical fibers 206 disposed therein. The heterogeneous integration refers to the assembly and packaging of multiple separately manufactured components onto a single chip to improve functionality. Specifically, the first component 201A and the second component 201B may be attached and detached to each other along a Z direction, the second component 201B and the third component 201C may be attached and detached to each other along an X direction, and the first component 201A is attached to the top surface ST of the substrate SB, thereby achieving heterogeneous integration between the light guiding device 200 and the photonic integrated circuit 100. By attaching or fixing the first component 201A to the top surface ST of the substrate SB and making each component detachable, the performance testing of the photonic integrated circuit 100 can be easily performed.

However, the disclosure is not limited thereto. In some embodiments, the first component 201A is detachable from the substrate SB.

It should be noted that, in a comparative example, the substrate SB is cut along a dashed line CC′ in FIG. 1A, in which the dashed line CC′ corresponds to the light outlet of each optical coupling element 102. That is to say, the light outlet of each optical coupling element 102 is located above the side surface formed after cutting the substrate SB, and the first component 201A of the light guiding device 200 is disposed on the side surface of the substrate SB to guide the light from each optical coupling element 102. In contrast, in the embodiment of the disclosure, there is no need to cut the substrate SB. The first component 201A may be disposed on the top surface ST of the substrate SB. The process of cutting the substrate SB can be omitted, and the structural strength of the heterogeneous integration structure 1 can be improved.

The light guiding device 200 in the embodiment of the disclosure further includes a plurality of lens elements 202 and a first reflector 203 disposed on the first component 201A, and a plurality of lens elements 204 and a second reflector 205 disposed on the second component 201B, in which the lens elements 202 and the lens elements 204 are aligned with the optical coupling elements 102 respectively. The first reflector 203 and the second reflector 205 may include high-reflectivity coating layers, and are inclined at 45 degrees with respect to the top surface ST of the substrate SB. When the first component 201A and the second component 201B are attached to each other, the first component 201A, the second component 201B, the lens elements 202, the first reflector 203, the lens elements 204, and the second reflector 205 are all on the top surface ST of the substrate SB.

In some embodiments, the laser light LA (first light) may be provided by the light sources 101 to perform performance testing of the photonic integrated circuit 100. The laser light LA reaches each optical coupling element 102. The laser light LA coming from each optical coupling element 102 sequentially passes through the corresponding lens element 202, gets reflected by the first reflector 203, passes through the corresponding lens element 204, gets reflected by the second reflector 205, and reaches the corresponding optical fiber 206 in the third component 201C (fiber connector). The laser light LA coming from the optical coupling element 102 has a beam width BS, and the beam width BS may be, for example, less than or equal to 10 microns. Moreover, by disposing the lens elements 202 and the lens elements 204, the efficiency of coupling the laser light LA in to the optical fiber 206 can be significantly improved.

In some embodiments, additional laser light (second light) may be provided by other laser sources (not shown). The laser light reaches each optical fiber 206 in the third component 201C. The laser light coming from each optical fiber 206 sequentially gets reflected by the second reflector 205, passes through the corresponding lens element 204, gets reflected by the first reflector 203, passes through the corresponding lens element 202, and reaches the corresponding optical coupling element 102. By disposing the lens elements 202 and the lens elements 204, the efficiency of coupling the laser light in to the optical coupling element 102 can be significantly improved.

In some embodiments, the lens elements 202 and the lens elements 204 may be microlenses, and the object side surface and image side surface of the microlens may be coated with optical films, but the disclosure is not limited thereto. In some embodiments, at least a portion of the lens elements 202 and the lens elements 204 may be meta-lens. By optimizing the size and arrangement of the plurality of nanostructures in the meta-lens, the efficiency of coupling the laser light LA in to the optical fiber 206 or in to the optical coupling element 102 can be significantly improved.

It should be noted that the light guiding device 200 provided by the embodiments of the disclosure is not limited to the foregoing structure. In some embodiments, the detachable module 201 includes the first component 201A and the third component 201C, and does not include the second component 201B. In the embodiments, each optical fiber 206 in the third component 201C is arranged parallel to the Z direction, and the first component 201A and the third component 201C may be attached and detached to each other along the Z direction. In some embodiments, the laser light LA coming from each optical coupling element 102 sequentially passes through the corresponding lens element 202, gets reflected by the first reflector 203, and reaches the corresponding optical fiber 206 in the third component 201C. In some embodiments, the laser light may be provided by other laser sources (not shown). The laser light reaches each optical fiber 206 in the third component 201C. The laser light coming from each optical fiber 206 sequentially gets reflected by the first reflector 203, passes through the corresponding lens element 202, and reaches the corresponding optical coupling element 102.

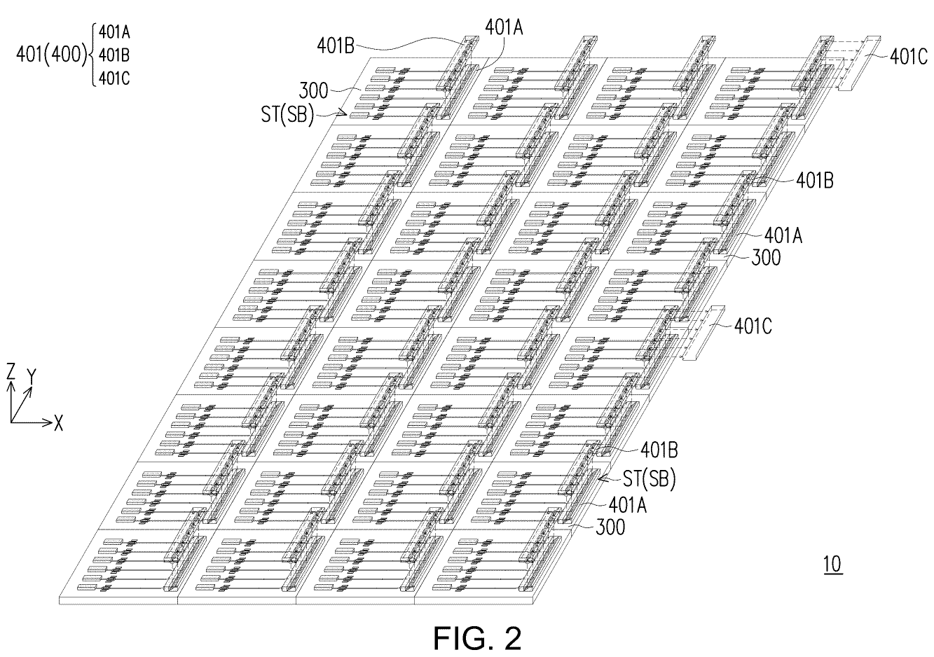

Referring to FIG. 2, which shows a schematic view of a heterogeneous integration wafer according to an embodiment of the disclosure.

A heterogeneous integration wafer 10 includes a plurality of photonic integrated circuits 300 arranged in an array and a plurality of light guiding devices 400 forming heterogeneous integration with the photonic integrated circuits 300 respectively. In the embodiment, the photonic integrated circuits 300 form a wafer, and the heterogeneous integration wafer 10 may be regarded as being formed by disposing the plurality of light guiding devices 400 on the wafer.

Each photonic integrated circuit 300 may be implemented by any of the photonic integrated circuits 100 described in all the foregoing embodiments. Moreover, the substrates SB of the photonic integrated circuits 300 are integrally formed, with the top surface ST of each substrate SB being coplanar.

Each light guiding device 400 includes a detachable module 401. The detachable module 401 includes a first component 401A, a second component 401B, and a third component 401C, in which the first component 401A may have the same or similar structure as the first component 201A, the second component 401B may have the same or similar structure as the second component 201B, and the third component 401C may have the same or similar structure as the third component 201C. It should be noted that, for the convenience of understanding, FIG. 2 merely illustrates part of the third component 401C of the detachable module 401. Specifically, each light guiding device 400 may be implemented by any of the light guiding devices 200 described in all the foregoing embodiments, and the heterogeneous integration wafer 10 may be regarded as being formed by multiple heterogeneous integration chips 1 arranged in an array.

It should be noted that each first component 401A of the heterogeneous integration wafer 10 is attached to the top surface ST of the substrate SB of the corresponding photonic integrated circuit 300, each first component 401A and the corresponding second component 401B are detachable, and each second component 401B and the corresponding third component 401C are detachable. Accordingly, the performance testing of any one of the photonic integrated circuits 300 can be easily performed.

In summary, the heterogeneous integration wafer provided according to the embodiments of the disclosure includes the multiple heterogeneous integration chips. The performance of each photonic integrated circuit may be tested through the detachable light guiding device of each heterogeneous integration chip. In particular, the first component of each light guiding device may be disposed on the top surface of the substrate of each photonic integrated circuit, without the need to cut the substrate. Therefore, the process of cutting the substrate can be omitted, and the structural strength of each heterogeneous integration chip and the heterogeneous integration wafer is high.

What is claimed is:

1. A heterogeneous integration structure, comprising:
a photonic integrated circuit comprising a substrate, at least one light source, and at least one optical coupling element, wherein the at least one light source and the at least one optical coupling element are disposed on the substrate, the at least one light source is configured to generate a first light, and the at least one optical coupling element is arranged in a path of the first light; and
a light guiding device forming heterogeneous integration with the photonic integrated circuit, and comprising:
at least one first lens disposed on the substrate and aligned with the at least one optical coupling element; and
a first reflector disposed on the substrate,
wherein the first light coming from the at least one optical coupling element sequentially passes through the at least one first lens, gets reflected by the first reflector, and reaches a fiber connector, or a second light coming from the fiber connector sequentially gets reflected by the first reflector, passes through the at least one first lens, and reaches the at least one optical coupling element.

2. The heterogeneous integration structure as claimed in claim 1, wherein the substrate has a top surface, and the at least one first lens and the first reflector are disposed on the top surface.

3. The heterogeneous integration structure as claimed in claim 1, wherein the photonic integrated circuit further comprises at least one optical modulator and at least one waveguide, and the at least one optical modulator, the at least one waveguide, and the at least one optical coupling element are sequentially arranged in the path of the first light.

4. The heterogeneous integration structure as claimed in claim 1, wherein the light guiding device further comprises a second reflector and a detachable module, the detachable module comprises a first component and a second component, the first reflector and the at least one first lens are disposed on the first component, and the second reflector is disposed on the second component.

5. The heterogeneous integration structure as claimed in claim 4, wherein the light guiding device further comprises at least one second lens element disposed on the second component and positioned between the first reflector and the second reflector.

6. The heterogeneous integration structure as claimed in claim 5, wherein at least one of the at least one first lens and the at least one second lens element comprises a meta-lens.

7. The heterogeneous integration structure as claimed in claim 4, wherein the substrate has a top surface, and the first component and the second component are disposed on the top surface.

8. The heterogeneous integration structure as claimed in claim 7, wherein the first component is attached to the top surface of the substrate.

9. The heterogeneous integration structure as claimed in claim 1, wherein the at least one optical coupling element comprises a spot size converter.

10. The heterogeneous integration structure as claimed in claim 9, wherein the first light coming from the at least one optical coupling element has a beam width, and the beam width is less than or equal to 10 microns.

11. The heterogeneous integration structure as claimed in claim 1, wherein the heterogeneous integration structure is formed into a heterogeneous integration chip.

12. A heterogeneous integration wafer, comprising a plurality of photonic integrated circuits arranged in an array and a plurality of light guiding devices forming heterogeneous integration with the plurality of photonic integrated circuits, wherein
each of the photonic integrated circuits comprises a substrate, at least one light source, and at least one optical coupling element, the at least one light source and the at least one optical coupling element are disposed on the substrate, the at least one light source is configured to generate a first light, the at least one optical coupling element is arranged in a path of the first light, and each of the light guiding devices comprises:
at least one first lens disposed on the substrate and aligned with a corresponding one of the at least one optical coupling element; and
a first reflector disposed on the substrate,
wherein the first light coming from the at least one optical coupling element sequentially passes through the at least one first lens, gets reflected by the first reflector, and reaches a fiber connector, or a second light coming from the fiber connector sequentially gets reflected by the first reflector, passes through the at least one first lens, and reaches the at least one optical coupling element.
